(19) United States
(12) Patent Application Publication
(10) Pub. No.: US 2006/0128896 A1
(43) Pub. Date: Jun. 15, 2006

(54) Composition comprising ethylene copolymer

(76) Inventors: Geraldine M. Lenges, Wilmington, DE (US); David C. Urian, Pennsville, NJ (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/298,042

(22) Filed: Dec. 9, 2005

Related U.S. Application Data
(60) Provisional application No. 60/635,165, filed on Dec. 10, 2004.

(51) Int. Cl. C08L 33/02; C08L 33/04

(52) U.S. Cl. 525/221; 525/191; 525/222

(57) ABSTRACT

A composition and a process for blocking water in an article are disclosed. The composition can comprise or be produced from a first polymer, a second polymer, and optionally a third polymer; the first polymer comprises an ethylene copolymer comprising repeat units derived from ethylene and a polar monomer; the second polymer comprises a polyacrylic acid or its salt or its cross-linked polymer thereof, a polymethacrylic acid or its salt or cross-linked polymer thereof, or combinations of two or more thereof; and the third polymer comprises polyvinyl alcohol. The process can comprise contacting the article with the composition.

This application claims the priority of U.S. provisional application Ser. No. 60/635,165, filed Dec. 10, 2004, the entire disclosure of which is incorporated herein by reference.

The invention relates to a composition comprising an ethylene copolymer, to an article comprising or produced from the composition, to a cable comprising or produced from the composition, and to a process for blocking water in an article such as a cable.

### BACKGROUND OF THE INVENTION

Cable is generally used in telecommunications or electrical power. If water enters the cable, water can corrode the metal part of the cable thereby damaging or impairing the telecommunications or power delivery. Water can also freeze within the cable thereby inducing microbending in the optical fibers of the cable, which consequently can result in fiber degradation or increased signal loss. A water-blocking or water-absorbing product can be used to prevent or reduce the potential water damage or transmission impairment. For example, water-blocking material is disposed in any otherwise empty space within a fluid impervious tube surrounding a plurality of optical fibers and between the outer layer and the tube. Also for example, water-blocking material is disposed between the transmission media and the outer jacket of the cable. As a further example, U.S. Pat. No. 6,278,826 discloses incorporating in cables a water-blocking foam with flame-retarding characteristics. As a further example, WO 98/25974 discloses using hydrophilic zeolites to remove residual acids or small esters from polymeric compositions.

It is highly desirable to provide an alternative water-blocking and/or absorbing “medium” in the form of, for example, a film that can be laminated to another portion of the cable structure.

### SUMMARY OF THE INVENTION

The invention includes a composition that can be used to absorb water. The composition can comprise or be produced from a first polymer, a second polymer, and optionally a third polymer in which the first polymer can comprise repeat units derived from ethylene and at least one polar monomer; the second polymer can be a polyacrylic acid or polymethacrylic acid, salt thereof, cross-linked polymer thereof, or combinations of two or more thereof, and the third polymer can be polyvinyl alcohol, polyacrylamide, partially hydrolyzed polyacrylamide, or combinations of two or more thereof.

The invention also includes an article comprising a water-blocking composition that can be used for absorbing water. The composition can be the same as that disclosed above.

Also included is a process that can be used to block or absorb water in an article. The process can comprise contacting an article such as a cable with a composition wherein the composition can be as disclosed above.

### DETAILED DESCRIPTION OF THE INVENTION

The first polymer is commonly referred to as an ethylene copolymer or ethylene acid polymer or ethylene polymer and can include an ionomer of the polymer. An ethylene copolymer is a copolymer comprising repeat units derived from ethylene and at least one polar monomer. The repeat units derived from the polar monomer can be present in the range of about 5 to about 50%, or about 10 to about 19%, or 12 to 15%, all weight percent (wt %) of the copolymer weight. A polar monomer can include acrylic acid, methacrylic acid, vinyl acetate, alkyl acrylate, or combinations of two or more thereof, based on the total weight of the ethylene copolymer. The alkyl group may contain up to about 20 carbon atoms such as methyl, ethyl, butyl, isobutyl, pentyl, hexyl, and combinations of two or more thereof.

Examples of such polar monomers include acrylic acid, methacrylic acid, ethacrylic acid, methyl acrylate, ethyl acrylate, methyl methacrylate, ethyl methacrylate, propyl acrylate, propyl methacrylate, isopropyl acrylate, isopropyl methacrylate, butyl acrylate, butyl methacrylate, isobutyl acrylate, isobutyl methacrylate, tert-butyl acrylate, tert-butyl methacrylate, 2-hydroxyethyl methacrylate, vinyl acetic acid, vinyl acetate, vinyl propionate, and combinations of two or more thereof.

An ethylene copolymer may comprise up to 35 wt % of an optional comonomer such as carbon monoxide, sulfur dioxide, acrylonitrile; maleic anhydride, dimethyl maleate, diethyl maleate, dibutyl maleate, dimethyl fumarate, diethyl fumarate, dibutyl fumarate, dimenthyl fumarate, maleic acid, maleic acid monoesters, itaconic acid, fumaric acid, fumaric acid monoester, a salt of these acids, glycidyl acrylate, glycidyl methacrylate, and glycidyl vinyl ether, and combinations of two or more thereof.

The acid moiety of an ethylene copolymer may be neutralized with a cation to produce an ionomer. The neutralization, for example, can range from about 0.1 to about 100, or about 10 to about. 90, or about 20 to 80, or about 20 to about 40 percent, based on the total carboxylic acid content, with a metallic ion. The metallic ions can be monovalent, divalent, trivalent, multivalent, or combinations of two or more thereof. Examples include Li, Na, K, Ag, Hg, Cu, Be, Mg, Ca, Sr, Ba, Cd, Sn, Pb, Fe, Co, Zn, Ni, Al, Sc, Hf, Ti, Zr, Ce, and combinations of two or more thereof. If the metallic ion is multivalent, a complexing agent, such as stearate, oleate, salicylate, and phenolate radicals can be included, as disclosed in U.S. Pat. No. 3,404,134. Frequently used include Na, Zn, or combinations thereof.

The ionomer can also be a blend of an ionomer having a greater than 20% neutralization and, for example, an ethylene (alkyl)acrylic acid copolymer to achieve the desired degree of neutralization.

For example, an ethylene alkyl acrylate copolymer can comprise from 1 to 30 weight % of at least one E/X/Y copolymer wherein E comprises ethylene; X is a monomer selected from the group consisting of vinyl acetate and alkyl acrylic esters; and Y is one or more optional comonomers disclosed above; X is from 0 to 50 weight % of the E/X/Y copolymer, Y is from 0 to 35 weight % of the E/X/Y copolymer, wherein the weight % of X and Y cannot both be 0, and E being the remainder.

Examples of ethylene copolymers include, but are not limited to, ethylene/acrylic acid (EAA), ethylene/vinyl acetate (EVA), ethylene/methyl acrylate (EMA), ethylene/ethyl acrylate (EEA), ethylene/butyl acrylate (EBA), ethylene/isobutyl acrylate (EiBA), ethylene/isobutyl acrylate/methacrylic acid, ethylene/methyl acrylate/maleic anhydride, ethylene/butyl acrylate/glycidyl methacrylate (EBAGMA), ethylene/butyl acrylate/carbon monoxide (EBACO), and combinations of two or more thereof.

Examples of commercially available ethylene copolymers include those available from E. I. du Pont de Nemours and Company (DuPont), Wilmington, Del. carrying the trademarks of Surlyn®, Nucrel®, Appeel®, Bynel®, Elvaloy®, and Elvax®.

Such ethylene copolymers can be produced by any means known to one skilled in the art using either autoclave or tubular reactors (e.g., U.S. Pat. No. 3,404,134, U.S. Pat. No. 5,028,674, U.S. Pat. No. 6,500,888 and U.S. Pat. No. 6,518,365).

For example, an ethylene copolymer can be produced at high pressure and elevated temperature in a tubular reactor. The inherent consequences of dissimilar reaction kinetics for the respective ethylene and alkyl acrylate (e.g. methyl acrylate) comonomers is alleviated or partially compensated by the intentional introduction of the monomers along the reaction flow path within the tubular reactor. Such tubular reactor-produced ethylene copolymer has a greater relative degree of heterogeneity along the polymer backbone (a more blocky distribution of comonomers), reduced long chain branching, and a higher melting point than one produced at the same comonomer ratio in a high pressure stirred autoclave reactor. For additional information for tubular reactor-produced and autoclave produced ethylene copolymers, see Richard T. Chou, Mimi Y. Keating and Lester J. Hughes, “High Flexibility EMA made from High Pressure Tubular Process”, Annual Technical Conference—Society of Plastics Engineers (2002), 60th(Vol. 2), 1832-1836. Tubular reactor produced ethylene copolymers are commercially available from DuPont.

The ionomers can be blended or melt-blended with other ionomers or polymers and/or modified by incorporation of organic acids or salts thereof. The organic acids or salts thereof, such as those particularly aliphatic, mono-functional organic acid(s) can have from 6 to 36 carbon atoms per molecule. The organic acids can be one or more at least partially neutralized, aliphatic, mono-functional organic acids having fewer than 36 carbon atoms or salt thereof. Also, greater than 80% or greater than 90% or even 100% of all the acid components in the blend can be neutralized. As disclosed above, the acids in the ionomer are at least partially neutralized by, for example, potassium ions. The organic acids can be non-volatile and non-migratory. Examples of organic acids are lauric acid, palmitic acid, stearic acid, oleic acid, erucic acid, behenic acid, or combinations of two or more thereof. These acids are also referred to as fatty acids.

The organic acids or salts thereof can be added in an amount sufficient to enhance the antistatic, gas permeation and antifog properties of the copolymer or ionomer over the non-modified copolymer ionomer such as at least about 5 wt %, or at least 15 wt %, or even 30 wt %, up to about 50 wt % of the total amount of copolymer (or ionomer) and organic acid(s).

Polyacrylic acid or polymethacrylic acid or salt thereof or cross-linked polymer thereof can be in powder or granule form. Polyacrylic acid or polymethacrylic acid or salt thereof or cross-linked polymer thereof is well known to one skilled in the art. The description of which is omitted herein for the interest of brevity. Examples of salts of polyacrylic acid or polymethacrylic acid can include ammonium or a metal salt such as a sodium salt of polyacrylic acid or polymethacrylic acid, which can be readily available from Aldrich Chemical, Milwaukee, Wis. or Sumitomo Seika Chemicals Co., Ltd, Japan.

The third polymer can be polyvinyl alcohol, polyacrylamide, partially hydrolyzed polyacrylamide, or combinations of two or more thereof. These polymers are well known to one skilled in the art and can be commercially available.

The composition can comprise the second polymer in the range of from about 1 to about 95 wt %, or about 5 to about 80 wt %, or about 10 to about 70 wt %, or 40 to 60 wt %, based on the weight of the composition. If the composition includes the third polymer such as polyvinyl alcohol or derivative thereof, the third polymer can be present in the range from about 1 to about 60 wt %, about 2 to about 50 wt %, or about 5 to about 40 wt %.

The composition can be produced by any means known to one skilled in the art such as, for example, dry blending, melt blending, extrusion, or combinations of two or more thereof. Because such means are well known to one skilled in the art, the description of which is omitted herein for the interest of brevity. In addition, a polymer melt obtained after extrusion can be cooled by air or cooled without water. A polymer melt can also be cooled on a moving belt under an inert gas such as nitrogen or a series of air ladders or air ring. A polymer melt can be optionally further cooled with dry ice, liquid nitrogen, or other means or aids to allow for sufficient cutting and pelletizing.

The composition can be in the form of powder, granule, pellet, film, multilayer film, or combinations of two or more thereof.

A shaped article can be produced from the composition. The shaped article may be in the form of films, sheets, filaments, tapes, molded products, thermoformed products, and containers for food or non-food packaging. Processes for producing these products are well known to one skilled in the art. For example, films can be produced by methods known to one skilled in the art such as, for example, solution casting, cast film extrusion, blown film extrusion, and thermoplastic film forming (e.g., calendering or stretching). Films can be oriented in one direction by hot-drawing in the machine direction with a tensioning device, and annealing. Films can also be oriented in two directions (machine direction and transverse direction) by suitable tensioning devices. Because such methods are well known to one skilled in the art, the description of which is omitted herein for the interest of brevity.

Films can also be multilayer films produced by laminating one or more films together either by lamination, coextrusion, or using adhesives. For example, a multilayer polymer film can involve two or more layers including an outermost structural layer, an inner barrier layer, and an innermost layer making contact with and compatible with the intended contents of the package and capable of forming seals necessary for enclosing the product to be contained within the package.

One of the articles can be a cable. Cable refers to the one used in telecommunication or power delivery or both. A telecommunication cable can include a core tube fixedly surrounded by an outer jacket. The outer jacket can be made from plastics or other similar material. The core tube can include a transmission medium such as optical fiber such as that disclosed in U.S. Pat. No. 6,278,826, which is incorporated herein by reference. Because a cable is well known to one skilled in the art, the description of which is omitted here for the interest of brevity.

The film can be used to make a container, which is a shaped article for use in packaging and includes box, blister pack, bottle, tray, cup, and other containers. Containers can be used for beverages, foods (e.g., meats, cheese, fish, poultry, nuts, and other edible items), spices, condiments, personal care products, fragrances, electronic components, medical devices, medicinal liquids, pharmaceuticals, and cosmetics.

### EXAMPLES

The following examples are provided to illustrate, but are not to be construed to unduly limit the scope of, the invention.

### Example 1

Aquakeep 10HSNF20 (Sodium salt of polyacrylic acid available from Sumitomo Seika Chemicals Co., Ltd, Japan), Elvax® (ethylene vinyl acetate copolymer available from DuPont) and Elvanol® (ethylene vinyl alcohol copolymer available from DuPont) were compounded on a 28 mm Werner and Pfleiderer twin-screw extruder and cast into 2 mil (0.51 mm) film from a 10 inch (25.4 cm) flat die. The compositions are shown in Table 1.

TABLE 1
films of compositions comprising Elvax ®

| | 10 SHNF20 | | | |
|---|---|---|---|---|
| Run No. | (wt %) | Elvax ® (wt %)^{A} | | Other (wt %) |
| 1 | 15 | 85 | (Elvax ® 40) | 0 |
| 2 | 15 | 85 | (Elvax ® 3180) | 0 |
| 3 | 15 | 63.75 | (Elvax ® 3180) | 21.25 |
| | | | | (Elvanol ® 75-15)^{B} |
| 4 | 30 | 70 | (Elvax ® 3180) | 0 |
| 5 | 15 | 83 | (Elvax ® 3180) | 2 |
| | | | | (Safoam ® RPC- |
| | | | | 40)^{C} |
| 6 | 40 | 60 | (Elvax ® 3175) | 0 |
| 7 | 50 | 50 | (Elvax ® 3175) | 0 |
| 8 | 60 | 40 | (Elvax ® 3175) | 0 |

^{A}Elvax ® 40: polymer comprising repeat units derived from 60 wt % ethylene and 40 wt % vinyl acetate having a melt index (MI) of 52; Elvax ® 3175: polymer comprising repeat units derived from 72 wt % ethylene and 28 wt % vinyl acetate, 6 MI; Elvax ® 3180: polymer comprising repeat units derived from 72 wt % ethylene and 28 wt % vinyl acetate having a MI of 40.
^{B}Elvanol ® 75-15: fully hydrolyzed polymer comprising repeat units derived from polyvinyl alcohol and methyl methacrylate having a degree of polymerization of 1000, obtained from DuPont.
^{C}Safoam ® RPC-40: foaming agent available from Reedy International Corporation.

Method a: The weight % absorption was determined by ASTM D570-7.2 by placing the conditioned specimen in a container of distilled water maintained at a temperature of 23° C., and resting the specimen on edge and entirely immersing the specimen. At the end of 2 hours, the specimen was removed from water, all surface water was wiped off with a dry cloth, and the dry cloth-dried specimen was immediately weighed to the nearest 0.001 g.

Method b: The weight % absorption was determined by placing the conditioned specimen in a cup or beaker of 100 g of distilled water and entirely immersing the specimen. At the end of 2 minutes (b1) or 2 hours (b2), the specimen and water were poured into a funnel containing presoaked filter paper and allowed to drain into a clean cup or beaker. The mixture was allowed to drain for fifteen minutes. The water was immediately weighed to the nearest 0.001 g.

The results are shown in Table 2.

TABLE 2
water absorption of film comprising Elvax ®

| | 10SHNF20 (wt | Water Absorption (wt % |
|---|---|---|
| Run No | %) | increase)* |
| Elvax ® 3175 | 0 | 0.42^{a} |
| Control | | |
| 1 | 15 | 65^{a} |
| 2 | 15 | 9.8^{a} |
| 3 | 15 | 84^{a} |
| 4 | 30 | 159^{a} |
| 5 | 15 | 9^{a} |
| 6 | 40 | 158^{b1}, 220^{b2} |
| 7 | 50 | 589^{b1}, 773^{b2} |
| 8 | 60 | 1059^{b1}, 1378^{b2} |

*“a” denotes results obtained using method a and “b” denotes results obtained using method b after immersing specimen 2 minutes (b1) or 2 hours (b2).

1. A composition comprising or produced from a first polymer, a second polymer, and optionally a third polymer; the first polymer comprises an ethylene copolymer comprising repeat units derived from ethylene and at least one polar monomer, an ionomer of the ethylene copolymer, a modified ionomer comprising an organic carboxylic acid, or combinations of two or more thereof; the second polymer comprises a polyacrylic acid or its salt or cross-linked polymer thereof, a polymethacrylic acid or its salt or cross-linked polymer thereof, or combinations of two or more thereof; the third polymer comprises polyvinyl alcohol, polyacrylamide, partially hydrolyzed polyacrylamide, or combinations of two or more thereof.

2. The composition of claim 1 wherein the polar monomer includes acrylic acid, salt of acrylic acid, methacrylic acid, salt of methacrylic acid, ethacrylic acid, salt of ethacrylic acid, methyl acrylate, ethyl acrylate, methyl methacrylate, ethyl methacrylate, propyl acrylate, propyl methacrylate, isopropyl acrylate, isopropyl methacrylate, butyl acrylate, butyl methacrylate, isobutyl acrylate, isobutyl methacrylate, tert-butyl acrylate, tert-butyl methacrylate, 2-hydroxyethyl methacrylate, vinyl acetic acid, salt or ester of vinyl acetic acid, vinyl acetate, vinyl propionate, or combinations of two or more thereof.

3. The composition of claim 1 wherein the first polymer is the polyvinyl alcohol.

4. The composition of claim 2 wherein the first polymer is the polyvinyl alcohol.

5. The composition of claim 1 wherein the first polymer is the ionomer of the ethylene copolymer or the modified ionomer comprising an organic carboxylic acid.

6. The composition of claim 2 wherein the first polymer is the ionomer of the ethylene copolymer or the modified ionomer comprising an organic carboxylic acid.

7. The composition of claim 1 wherein the second polymer comprises a salt of the polyacrylic acid, a salt of the polymethacrylic acid, or both.

8. The composition of claim 2 wherein the second polymer comprises a salt of the polyacrylic acid, a salt of the polymethacrylic acid, or both.

9. The composition of claim 4 wherein the second polymer comprises a salt of the polyacrylic acid, a salt of the polymethacrylic acid, or both.

10. The composition of claim 6 wherein the second polymer comprises a salt of the polyacrylic acid, a salt of the polymethacrylic acid, or both.

11. The composition of claim 2 further comprising the third polymer.

12. The composition of claim 4 further comprising the third polymer.

13. The composition of claim 8 further comprising the third polymer.

14. The composition of claim 9 further comprising the third polymer.

15. The composition of claim 10 further comprising the third polymer.

16. An article having incorporated thereon or therein a composition wherein the article includes film, sheet, filament, tape, molded product, thermoformed product, cable or container; the composition is as recited in claim 1; and the container includes box, blister pack, bottle, tray, or cup and preferably comprises beverage, food, spice, condiment, personal care product, fragrance, electronic component, medical device, medicinal liquid, pharmaceutical, cosmetic, or combinations of two or more thereof.

17. The article of claim 16 wherein the composition is as recited in claim 15.

18. The article of claim 17 wherein the article is the cable; the cable comprises a core tube, an outer jacket, and the composition; the core tube is surround by the outer jacket; and the composition is disposed within the core tube, between the core tube and the outer jacket, or incorporated on the core tube or the inner surface of the outer jacket.

19. A process comprising contacting an article with a composition wherein the article and the composition are each as recited in claim 16.

20. The process of claim 19 wherein the article is the cable as recited in claim 18.
